(19) United States
(12) Patent Application Publication
(10) Pub. No.: US 2026/0242621 A1
(43) Pub. Date: Aug. 20, 2026

(54) SELF-ASSEMBLED ELECTRICALLY CONDUCTING SYSTEM, METHOD OF MANUFACTURING THEREOF AND ARTICLES COMPRISING THE SAME

(71) Applicant: University of Connecticut, Farmington, CT (US)

(72) Inventors: Luyi Sun, Storrs, CT (US); Montgomery Shaw, Coventry, CT (US); Kuangyu Shen, North Haven, CT (US); Tiantian Li, Willington, CT (US)

(21) Appl. No.: 19/426,589

(22) Filed: Dec. 19, 2025

Related U.S. Application Data
(60) Provisional application No. 63/760,455, filed on Feb. 19, 2025.

(51) Int. Cl. C09D 5/24; C08F 8/34; C08K 3/08; C09D 7/61; C09D 153/02; C22C 28/00; D01F 8/10; D01F 8/18; D03D 15/292; D03D 15/533

(52) U.S. Cl. CPC C09D 5/24; C08F 8/34; C09D 7/61; C09D 153/025; C22C 28/00; D01F 8/10; D01F 8/18; D03D 15/292; D03D 15/533; C08K 3/08; C08K 2201/001; D10B 2401/16; D10B 2505/00

(57) ABSTRACT

Disclosed herein is a composition for manufacturing an electrically conducting composite, the composition comprising a polymer comprising a surface energy reducing moiety; wherein the surface energy reducing moiety comprises a silicon atom, a fluorine atom, or both a silicon atom and a fluorine atom; a liquid metal; and a solvent; wherein the composition is operative to undergo self-assembly into an electrically conducting composite that comprises a jacket that comprises the polymer and a strand that comprises the liquid metal. Disclosed herein too is an article comprising an electrically conducting composite comprising a liquid metal strand disposed in an encapsulating polymeric jacket; wherein the liquid metal strand extends continuously from one end to another end of the encapsulating polymeric jacket; and wherein the encapsulating polymeric jacket comprises a surface energy reducing moiety; wherein the surface energy reducing moiety comprises a low surface energy moiety.

### CROSS-REFERENCE TO RELATED APPLICATIONS

This application claims the benefit of U.S. Provisional Application Ser. No. 63/760,455, filed Feb. 19, 2025, which is incorporated herein by reference in its entirety.

### STATEMENT REGARDING FEDERALLY SPONSORED RESEARCH

This invention was made with government support under grant 1822147 awarded by the National Science Foundation. The government has certain rights in the invention.

### BACKGROUND OF THE INVENTION

### 1. Field of the Invention

Disclosed herein is a self-assembled electrically conducting system, methods of manufacture thereof and articles comprising the same.

### 2. Description of the Related Art

Establishing electrical conductivity in soft or stretchable articles has substantial commercial value. For example, consider applications using wearable sensors for physiological monitoring. The wearable sensors measure heart rate or muscle activity. Related examples include flexible patches for electroencephalography, electromyography, and electrocardiography. The flexibility and elasticity of the article permit comfort during motion. The design remains limited by maximum strain tolerance and signal noise under repeated deformation.

A second application includes e-textiles for interactive garments. The garments enable gesture tracking or temperature regulation. Related examples include illuminated clothing, tactile feedback interfaces, and shape-changing sleeves. The embedded conductors must withstand laundering and daily wear. The design remains limited by chemical exposure and mechanical stress during washing or abrasion.

A third application includes soft robotics. Soft actuators incorporate conductive lines for sensing and control. Related examples include stretchable sensors along joints, flexible circuit traces, and integrated haptic feedback. The design allows safe interaction with delicate objects. The design remains limited by the mechanical fatigue of conductive paths under repeated flexing.

A fourth application includes biomedical devices for wound dressings or tissue engineering. Conductive films can monitor healing or deliver electrical stimulation. Related examples include smart bandages for infection detection, conductive scaffolds for tissue growth, and flexible leads for neural interfaces. The design must ensure biocompatibility and withstand sterilization. The design remains limited by material degradation in wet or harsh physiological conditions.

Another application includes soft energy storage devices. Stretchable electrodes can form batteries or supercapacitors. Related examples include elastic battery cells for wearable electronics, collapsible power sources for robotic skins, and conformal supercapacitor mats. The design enables integration into curved or deformable surfaces. The design remains limited by electrolyte leakage and reduced capacity during repeated expansion.

Unfortunately, design of stretchable electronics poses a persistent challenge. The challenge in achieving stretchable electronics stems from the inherent limitations of regular continuous conductors, such as, for example regular metallic solids, which lack stretchability. On the other hand, when endeavoring to impart stretchability through the incorporation of conductive fillers, the conductive network formed by these fillers often experiences breakage during deformation. This phenomenon leads to a substantial decrease in conductivity, presenting a significant hurdle in the development of reliable stretchable electronics.

What are needed are methods and apparatus for stretchable electronics that provide substantial elasticity (i.e., have elongations over 50% of their original length) without failure and high recoverability, while being continuously electrically conducting.

### SUMMARY OF THE INVENTION

Disclosed herein is a composition for manufacturing an electrically conducting composite, the composition comprising a polymer comprising a surface energy reducing moiety; wherein the surface energy reducing moiety comprises a silicon atom, a fluorine atom, or both a silicon atom and a fluorine atom; a liquid metal; and a solvent; wherein the composition is operative to undergo self-assembly into an electrically conducting composite that comprises a jacket that comprises the polymer and a strand that comprises the liquid metal.

Disclosed herein too is an article comprising an electrically conducting composite comprising a liquid metal strand disposed in an encapsulating polymeric jacket; wherein the liquid metal strand extends continuously from one end to another end of the encapsulating polymeric jacket; and wherein the encapsulating polymeric jacket comprises a surface energy reducing moiety; wherein the surface energy reducing moiety comprises a low surface energy moiety.

Disclosed herein too is an article comprising an electrically conducting composite comprising a liquid metal strand disposed in an encapsulating polymeric jacket; wherein the liquid metal strand extends continuously from one end to another end of the encapsulating polymeric jacket; and wherein the encapsulating polymeric jacket comprises a surface energy reducing moiety; wherein the surface energy reducing moiety comprises a low surface energy moiety.

### BRIEF DESCRIPTION OF THE DRAWINGS

The features and advantages of the invention are apparent from the following description taken in conjunction with the accompanying drawings in which:

FIG. 1 depicts a portion of an exemplary strand of the electrically conductive composite that comprises a polymer jacket with a liquid metal strand disposed therein;

FIG. 2 depicts the reaction scheme where a styrene-butadiene-styrene triblock copolymer has a fluorine-containing moiety grafted on to it;

FIG. 3 depicts digital photographs of the printed liquid metal wires disposed on a polyurethane substrate at a pump speed of 1.6 microliters per second (μL/s) and a printing speed of 10 mm/s;

FIGS. 4 and 5 are schematic diagrams that depict the strategy behind using self-assembly to form a liquid metal/polymer structure, where the liquid metal forms the core and the polymer forms the jacket (also known as the shell);

FIG. 6A is a photograph that depicts a strand of the electrically conducting composite that has a SBS jacket disposed on a eutectic gallium indium (EGaIn) liquid metal core; and

FIG. 6B is a photograph that depicts two regions (see rectangles) of the electrically conducting composite strand that are sliced to expose the eutectic gallium indium liquid metal core strand inside the SBS jacket.

### DETAILED DESCRIPTION OF THE INVENTION

Disclosed herein is an electrically conducting composite that comprises a liquid metal strand disposed in a polymeric jacket. The electrically conductive composite is stretchable when the polymeric jacket is an elastomer. The electrically conducting composite maintains its electrical conductivity when deformed and can return to its original shape upon removal of a deforming force. It suffers negligible hysteresis in electrical conductivity upon removal of the deforming force.

As discussed herein, the jacket is also referred to herein as a “shell.” The liquid metal strand is a substantially one-dimensional strand and extends continuously from one end to the other along the length of the electrically conducting composite and continues to be electrically conducting even upon being submitted to amounts of deformation (e.g., strain) greater than 100%. In an embodiment, the electrically conducting composite is manufactured by additive manufacturing (e.g., using a liquid 3D printing device). A paste of the polymer (that forms the polymeric jacket) and the liquid metal is ejected from a nozzle onto a substrate, whereupon self-assembly (also referred to herein as phase separation) occurs to promote the formation of a polymeric jacket on a continuous strand of liquid metal. The strand of liquid metal may be considered the “core” while the polymeric jacket is considered the “shell” and the combination is sometimes referred to as having a core-shell morphology.

The electrically conducting composite may be advantageously used in a wide variety of wearable technologies. Wearable technology has revolutionized the way individuals monitor their health and interact with their environment. Central to the functionality of wearable devices is electrical conductivity, as these systems rely on conductive materials to transmit signals, power sensors, and ensure reliable data collection. From fitness trackers and smartwatches to advanced medical-grade devices, electrical conductivity enables the integration of sensors that measure parameters like heart rate, body temperature, and muscle activity.

The disclosed electrically conducting composite is flexible, lightweight and biocompatible and can be used in wearables that conform seamlessly to the human body without compromising electrical performance. The electrically conducting composite is advantageous in that it can be deformed to levels greater than 100% of its original length and not suffer any significant reduction in electrical conductivity upon removal of the deforming force. This characteristic permits a wearable to maintain its electrical conductivity while being stretchable, durable, and resistant to environmental factors such as perspiration and movement. The composite can replace or be used in conjunction with alternative electrically conductive materials such as conductive polymers, carbon-based materials, metallic particles and nanowires, all of which are currently used to provide wearables with electrical conductivity. In addition, the shape and properties of the electrically conducting composite can be simply tuned by adjusting the composition that is fed to an additive manufacturing printing device. All the ingredients desired for manufacturing the electrically conductive composite are readily available commercially thereby facilitating efficient mass production of the composite.

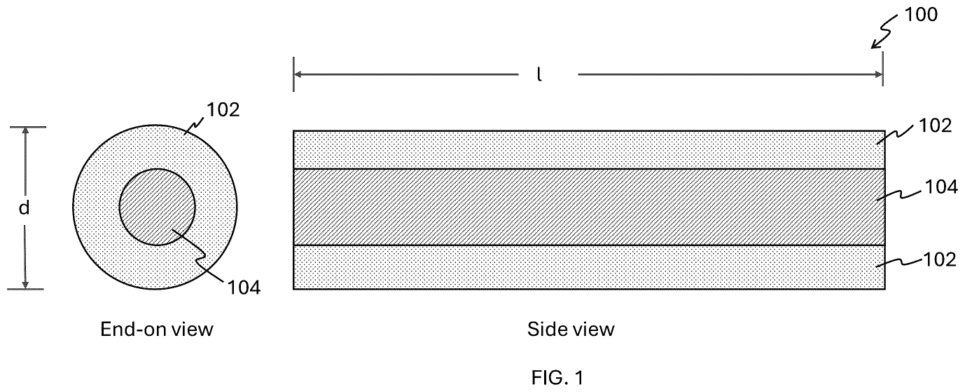

FIG. 1 depicts an end-on view and side view of an exemplary electrically conducting composite 100 that comprises a polymeric jacket 102 and a liquid metal strand 104. The polymeric jacket 102 may be in direct contact with the liquid metal strand 104. The electrically conducting composite 100 may be manufactured by extruding a mixture of the liquid metal, the polymer and a solvent from the nozzle of a liquid 3D printer. Self-assembly facilitates the polymer separating from the liquid metal to form an electrically conducting composite 100 in which the liquid metal strand 104 is encapsulated by the polymeric jacket. While the FIG. 1 depicts the resulting electrically conducting composite 100 in the form of a strand of length 1 and diameter d, it may be extruded in the form of a slab, a cube, or any other 2- or 3-dimensional shape.

The polymeric jacket 102 generally comprises an organic polymer. The organic polymer may be selected from a wide variety of thermoplastic polymers, blend of thermoplastic polymers, crosslinked polymers (e.g., thermosetting polymers), or blends of thermoplastic polymers with thermosetting polymers. The organic polymer may also be a blend of polymers, copolymers, terpolymers, or combinations comprising at least one of the foregoing organic polymers. The organic polymer can also be an oligomer, a homopolymer, a copolymer, a block copolymer, an alternating block copolymer, a random polymer, a random copolymer, a random block copolymer, a graft copolymer, a star block copolymer, a dendrimer, a polyelectrolyte (polymers that have some repeat groups that contain electrolytes), a polyampholyte (a polyelectrolyte having both cationic and anionic repeat groups), an ionomer, or the like, or a combination comprising at least one of the foregoing organic polymers. The organic polymers have number average molecular weights greater than 10,000 grams per mole, preferably greater than 20,000 g/mole and more preferably greater than 50,000 g/mol.

Examples of thermoplastic polymers include a polyacrylic, a polycarbonate, a polyalkyd, a polystyrene, a polyolefin, a polyester, a polyamide, a polyaramid, a polyamideimide, a polyarylate, a polyurethane, an epoxy, a phenolic, a polysiloxane, a polyarylsulfone, a polyethersulfone, a polyphenylene sulfide, a polysulfone, a polyimide, a polyetherimide, a polytetrafluoroethylene, a polyetherketone, a polyether ether ketone, a polyether ketone ketone, a polybenzoxazole, a polyoxadiazole, a polybenzothiazole, a polybenzothiazinophenothiazine, a polypyrazinoquinoxaline, a polypyromellitimide, a polyguinoxaline, a polybenzimidazole, a polyoxindole, a polyoxoisoindoline, a polydioxoisoindoline, a polytriazine, a polypyridazine, a polypiperazine, a polypyridine, a polypiperidine, a polytriazole, a polypyrazole, a polycarborane, a polyoxabicyclononane, a polydibenzofuran, a polyphthalide, a polyacetal, a polyanhydride, a polyvinyl ether, a polyvinyl thioether, a polyvinyl alcohol, a polyvinyl ketone, a polyvinyl halide, a polyvinyl nitrile, a polyvinyl ester, a polysulfonate, a polysulfide, a polythioester, a polysulfone, a polysulfonamide, a polyurea, a polyphosphazene, a polysilazane, a polyolefin, or the like, or a combination thereof.

In an embodiment, it is desirable for the polymeric jacket 102 to be an elastomer. The elastomer may be a thermoplastic elastomer or a crosslinked elastomer. Crosslinked elastomers obtained via thermosetting may be used. Elastomers are useful as jackets for electrical conductors due to their exceptional flexibility, durability, and insulating properties. Their inherent elasticity allows them to stretch and bend without cracking, making them suitable for cables and wires subjected to frequent movement or tight bends. Additionally, elastomers provide excellent resistance to environmental factors such as moisture, UV radiation, and temperature fluctuations, ensuring the long-term reliability of the electrical insulation. Their non-conductive nature prevents electrical leakage, while their capacity to be formulated with flame-retardant additives enhances safety in high-risk environments.

Suitable elastomers are polybutadienes, polyisoprenes, styrene-butadiene rubber, poly(styrene)-block-poly (butadiene) (having a diblock architecture), poly(styrene)-poly (butadiene)-poly(styrene) (having a triblock architecture) (also referred to herein as a styrene-butadiene-styrene triblock copolymer (SBS)), poly(acrylonitrile)-block-poly (styrene)-block-poly (butadiene) (ABS), polychloroprenes, epichlorohydrin rubber, polyacrylic rubber, silicone elastomers (polysiloxanes), fluorosilicone elastomers, fluoroelastomers, perfluoroelastomers, polyether block amides (PEBA), chlorosulfonated polyethylene, ethylene propylene diene rubber (EPR), styrene-ethylene-butadiene elastomers (SEBS), ethylene-vinyl acetate elastomers (EVA), or the like, or a combination thereof.

In one embodiment, the organic polymer used to manufacture the jacket preferably contains a polymer that comprises a surface free energy reducing moiety. Examples of such surface free energy reducing moieties are molecules that include silicon atoms, fluorine atoms, or both fluorine and silicon atoms. Low surface free energy polymers typically have a surface energy of less than or equal to 30 milliNewtons per meter (mN/m), preferably less than or equal to 28 mN/m, preferably less than or equal to 25 mN/m or below, and more preferably less than 22 mN/m. From the Table 1 it may be seen that some polymers containing fluorine atoms (e.g., polytetrafluroethylene and polytrifluoroethylene) and/or silicon (e.g., polydimethylsiloxane) atoms have a surface energy of less than or equal to 30 milliNewtons per meter (mN/m). Polymers that contain the aforementioned surface energy reducing moieties tend to migrate to a free surface of an article after being molded. In the present disclosure, after a paste containing the liquid metal and molten or solvated polymer are cast onto a surface, the polymer tends to migrate to the surface of the article and encapsulate the liquid metal.

TABLE 1

| | | Surface free | Temp. | Dispersive | Polar |
|---|---|---|---|---|---|
| | | energy (SFE) | coefficient | contrib. of | contrib. of |
| | CAS Ref.- | at 20° C. in | SFE in | SFE in | SFE in |
| Name | No. | mN/m | mN/(m K) | mN/m | mN/m |
| Polyethylene-linear PE | 9002-88-4 | 35.7 | −0.057 | 35.7 | 0 |
| Polyethylene-branched PE | 9002-88-4 | 35.3 | −0.067 | 35.3 | 0 |
| Polypropylene-isotactic PP | 25085-53-4 | 30.1 | −0.058 | 30.1 | 0 |
| Polyisobutylene PIB | 9003-27-4 | 33.6 | −0.064 | 33.6 | 0 |
| Polystyrene PS | 9003-53-6 | 40.7 | −0.072 | (34.5) | (6.1) |
| Poly-α-methyl styrene PMS | 9017-21-4 | 39.0 | −0.058 | (35) | (4) |
| (Polyvinyltoluene PVT) | | | | | |
| Polyvinyl fluoride PVF | 24981-14-4 | 36.7 | — | (31.2) | (5.5) |
| Polyvinylidene fluoride PVDF | 24937-79-9 | 30.3 | — | (23.3) | (7) |
| Polytrifluoroethylene P3FEt/PTrFE | 24980-67-4 | 23.9 | — | 19.8 | 4.1 |
| Polytetrafluoroethylene PTFE | 9002-84-0 | 20 | −0.058 | 18.4 | 1.6 |
| (Teflon ™) | | | | | |
| Polyvinylchloride PVC | 9002-86-2 | 41.5 | — | (39.5) | (2) |
| Polyvinylidene chloride PVDC | 9002-85-1 | 45.0 | — | (40.5) | (4.5) |
| Polychlorotrifluoroethylene PCTrFE | 25101-45-5 | 30.9 | −0.067 | 22.3 | 8.6 |
| Polyvinylacetate PVA | 9003-20-7 | 36.5 | −0.066 | 25.1 | 11.4 |
| Polymethylacrylate (Polymethacrylic | 25087-26-7 | 41.0 | −0.077 | 29.7 | 10.3 |
| acid) PMAA | | | | | |
| Polyethylacrylate PEA | 9003-32-1 | 37.0 | −0.077 | 30.7 | 6.3 |
| Polymethylmethacrylate PMMA | 87210-32-0 | 41.1 | −0.076 | 29.6 | 11.5 |
| Polyethylmethacrylate PEMA | 9003-42-3 | 35.9 | −0.070 | 26.9 | 9.0 |
| Polybutylmethacrylate PBMA | 25608-33-7 | 31.2 | −0.059 | 26.2 | 5.0 |
| Polyisobutylmethacrylate PIBMA | 9011-15-8 | 30.9 | −0.060 | 26.6 | 4.3 |
| Poly(tert-butylmethacrylate) PtBMA | 25189-00-8 | 30.4 | −0.059 | 26.7 | 3.7 |
| Polyhexylmethacrylate PHMA | 25087-17-6 | 30.0 | −0.062 | (27.0) | (3) |
| Polyethyleneoxide PEO | 25322-68-3 | 42.9 | −0.076 | 30.9 | 12.0 |
| Polytetramethylene oxide PTME | 25190-06-1 | 31.9 | −0.061 | 27.4 | 4.5 |
| (Polytetrahydrofurane PTHF) | | | | | |
| Polyethyleneterephthalate PET | 25038-59-9 | 44.6 | −0.065 | (35.6) | (9) |
| Polyamide-6,6 PA-66 | 32131-17-2 | 46.5 | −0.065 | (32.5) | (14) |
| Polyamide-12 PA-12 | 24937-16-4 | 40.7 | — | 35.9 | 4.9 |
| Polydimethylsiloxane PDMS | 9016-00-6 | 19.8 | −0.048 | 19.0 | 0.8 |
| Polycarbonate PC | 24936-68-3 | 34.2 | −0.04 | 27.7 | 6.5 |
| Polyetheretherketone PEEK | 31694-16- | 42.1 | — | 36.2 | 5.9 |
| | 13 | | | | |

Examples of polymers that contain fluorine atoms include polyvinylidene fluoride, polytetrafluoroethylene, polytrifluoroethylene, fluorinated ethylene propylene (FEP), perfluoroalkoxy (PFA) polymers, ethylene-tetrafluoroethylene (ETFE) polymers, chlorotrifluoroethylene (CTFE) and its copolymers (PCTFE), copolymers of hexafluoropropylene (HFP) and vinylidene fluoride (VDF), tetrafluoroethylene-propylene (FEPM), fluorosilicones, hydrogenated nitrile butadiene rubber with fluorinated modifications (HNBR-F), or the like or a combination thereof. Fluorinated polymers that are elastomers at room temperature are preferred.

Examples of polymers that contain silicon atoms include polydimethylsiloxane, polymethylphenylsiloxane, or the like, or a combination thereof.

In another embodiment, non-fluorinated polymers (e.g., polystyrene, poly(styrene)-block-poly (butadiene)) (having a diblock architecture), poly(styrene)-poly (butadiene)-poly (styrene) (having a triblock architecture), poly(acrylonitrile)-block-poly (styrene)-block-poly (butadiene) (ABS), ethylene propylene diene rubber (EPR), styrene-ethylene-butadiene elastomers (SEBS), ethylene-vinyl acetate elastomers (EVA), and so on) may be copolymerized with a monomer or copolymer that contains a low surface free energy moiety (e.g., a fluorine atom, a silicon atom, or both fluorine and silicon atoms). Copolymers of any of the aforementioned thermoplastic polymers with a fluorine containing moiety and/or a silicon containing moiety may also be used as the jacket in the electrically conducting composite. The resulting copolymer may be a block copolymer, a random copolymer or a graft copolymer.

Examples of the fluorine containing moiety (that may be covalently or ionically bonded to the foregoing non-fluorinated polymers) are shown below in formula (1):

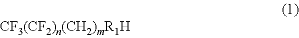

where R₁ is a heteroatom that comprises —O—, —S—, or —C(O)—, n is an integer from 1 to 12, preferably 2 to 10, and more preferably 3 to 8 and m is an integer from 1 to 12, preferably 2 to 10, and more preferably 3 to 8. In a preferred embodiment n is 6, 7 or 8, while m is 1, 2 or 3.

Examples of the fluorine-containing moieties of formula (1) include 3,3,4,4,5,5,6,6,7,7,8,8,8-tridecafluoro-1-octanethiol, 1H, 1H,2H,2H-perfluorodecanethiol, 1H, 1H,2H,2H-perfluoro-1-octanol, 2,2,3,3,4,4,4-heptafluoro-1-butanol, or a combination thereof.

An exemplary polymer is a styrene-butadiene-styrene triblock copolymer or styrene-ethylene-butadiene styrene copolymer that is hydrogenated with at least one of 1H,1H,2H,2H-perfluorodecanethiol, 1H,1H,2H,2H-perfluoro-1-octanol, 2,2,3,3,4,4,4-heptafluoro-1-butanol. In an embodiment, the fluorine-containing moiety is covalently bonded to the styrene-butadiene-styrene triblock copolymer as a graft. A graft is a pendant group and is covalently bonded onto the chain backbone of the polymer.

In an embodiment, the polymer may comprise additives such as, for example, fillers and reinforcing agents, dyes and colorants, gelling agents, antioxidants, antiozonants, flame-retardants, thermal-stabilizers, mold release agents, and the like, or a combination thereof.

The polymer may be present in the electrically conducting composite in an amount of 5 to 40 wt %, preferably 6 to 30 wt %, and more preferably 10 to 25 wt %, based on a total weight of the electrically conducting composite.

In an embodiment, the organic polymer may be dissolved in a solvent prior to being discharged from the nozzle of an additive manufacturing device. The solvent is one that preferably can completely compatibilize the polymer while not affecting the liquid metal that forms the electrically conducting backbone of the electrically conducting composite. The solvent is preferably a non-fluorinated solvent. Examples of a suitable solvents include aprotic polar solvents, polar protic solvents, non-polar solvents, or a combination thereof.

Liquid aprotic polar solvents such as acetone, propylene carbonate, ethylene carbonate, butyrolactone, acetonitrile, benzonitrile, nitromethane, nitrobenzene, sulfolane, dimethylformamide, N-methylpyrrolidone, or the like, or a combination thereof. Polar protic solvents such as water, methanol, acetonitrile, nitromethane, ethanol, propanol, isopropanol, butanol, or the like, or a combination thereof. Other non-polar solvents such a benzene, toluene, methylene chloride, carbon tetrachloride, hexane, diethyl ether, tetrahydrofuran, or the like, or a combination thereof. Co-solvents comprising at least one aprotic polar solvent and at least one non-polar solvent may also be utilized to modify the swelling power of the solvent and thereby adjust the rate of self-assembly.

In an embodiment, a single solvent or a plurality of solvents may be used to solvate the polymer and create a paste (also referred to herein as an ink) that can be printed using additive manufacturing. In an embodiment, a co-solvent system comprising two-non-fluorinated solvents may be used to solubilize the polymer and create a paste that can be printed onto a substrate. In a preferred embodiment, a co-solvent system comprising acetone and toluene may be used to solvate the polymer to form a paste (also referred to herein as an ink) in which the liquid metal is dispersed.

In one embodiment, the solvent can comprise a co-solvent system that contains a non-fluorinated solvent along with a fluorinated solvent. The non-fluorinated solvent is optional. The non-fluorinated solvent is preferably at least partially compatible with the solvent. The non-fluorinated solvent is compatible with the polymer and solvates it. The fluorinated solvent may facilitate self-assembly of the polymer and the liquid metal to form the polymer jacket 102.

Examples of fluorinated solvents include hydrofluoroethers (HFEs), perfluorocarbons (PFCs), hydrofluorocarbons (HFCs), fluorinated ketones, chlorofluorocarbons (CFCs), hydrochlorofluorocarbons (HCFCs), perfluoropolyethers (PFPEs), or a combination thereof.

When a combination of non-fluorinated solvents and fluorinated solvents are used, the non-fluorinated solvent is present in an amount of 5 to 95 wt %, preferably 30 to 70 wt %, based on the total weight of the solvent used. The fluorinated solvent is present in an amount of 5 to 95 wt %, preferably 30 to 70 wt %, based on the total weight of the solvent used.

The solvent (e.g., the sum of the non-fluorinated and optional fluorinated solvent) may be used in an amount of 5 to 85 wt %, preferably 10 to 80 wt %, and more preferably 20 to 60 wt %, based on a total weight of the mixture before extrusion from the nozzle of the additive manufacturing device. The mixture as defined herein comprises the polymer (that forms the jacket during self-assembly, the liquid metal and the solvent.

In an embodiment, the liquid metal is in a liquid state at the temperature of manufacturing of the electrically conducting composite. In another embodiment, the liquid metal is in a liquid state at room temperature (approximately 23° C.). In yet another embodiment, the liquid metal is in a liquid state when it is used as the core in an electrically conducting composite. The liquid metal is electrically conducting and is preferably in the liquid state from −100° C. (minus 100° C.) to 85° C., preferably −50° C. (minus 50° C.) to 50° C., and more preferably from 10° C. to 40° C. It is preferably in the liquid state at room temperature. The liquid metal is capable of wetting the surface of the polymer jacket and has a contact angle of less than 90 degrees when it contacts the polymer used in the jacket. In other words, the liquid metal shows spreading behavior when encapsulated by the metal jacket. This tendency to spread enables the metal to establish continuous electrical conductance in at least one direction from one end of the article (e.g., the strand) to the other.

The liquid metal generally comprises alloys such as Galinstan (which comprises gallium (Ga), indium (In) and tin (Sn) having a melting point of approximately −19° C. (minus 19° C.) (−2° F.) (minus 2° C.)), Field's metal (which comprises bismuth (Bi), indium (In) and tin (Sn) having a melting point of approximately 62° C. (144° F.)), eutectic gallium-indium (EGaIn) (which comprises gallium (Ga) and indium (In) having a melting point of 15.7° C. (60° F.)), Wood's metal (which comprises bismuth (Bi), lead (Pb), tin (Sn) and cadmium (Cd) having a melting point of 70° C. (158° F.)), Rose's metal (which comprises bismuth (Bi), lead (Pb) and tin (Sn) having a melting point of 98° C. (208° F.), mercury-based alloys (amalgams) (which comprise mercury combined with various metals (e.g., silver, gold, or tin), NaK (sodium-potassium alloy) (which comprises sodium (Na) and potassium (K) having a melting point of −12.6° C. (9.3F)), or a combination thereof.

A preferred liquid metal is eutectic gallium-indium where the gallium is present in an amount of 60 to 85 wt %, preferably 70 to 80 wt % and the indium is present in an amount of 15 to 40 wt %, preferably 20 to 30 wt %, based on a total weight of the liquid metal.

The liquid metal may be present in the electrically conducting composite in an amount of 80 to 95 wt %, preferably 90 to 94 wt %, and more preferably 80 to 85 wt %, based on a total weight of the electrically conducting composite.

The liquid metal may have a diameter d₁ of 10 micrometers to 5 millimeters, preferably 15 micrometers to 2 millimeters and more preferably 20 micrometers to 1.5 millimeters.

In one embodiment, in one method of manufacturing the electrically conducting composite, the polymer, the solvent and the liquid metal are mixed to form a mixture. The mixture is typically in the form of a paste (also referred to as an ink). The liquid metal particles in the paste are dispersed as spherical particles.

The paste may be subjected to an additive manufacturing process where it is extruded through the nozzle of the manufacturing device to form a strand. In an embodiment, the additive manufacturing may be fused deposition modeling (FDM). FDM works by depositing material layer by layer to create a three-dimensional object.

In the FDM process, a thermoplastic filament (the electrically conductive composite in mixture form) is fed through a heated printer head, which then melts the material. The melted material is extruded through a fine nozzle onto a build platform, where it cools and solidifies, creating a thin layer of the object. The printer head moves along predetermined paths, depositing the material layer by layer according to the design specifications provided by a computer-aided design (CAD) program. The temperature of the printer head is 13 to 18° C., ensuring a usable printable viscosity of the solution. The temperature of the substrate can be 25 to 40° C. The increase in temperature of the substrate will accelerate the evaporation of solvents and the self-assembly of molecules.

In an embodiment, upon extruding the paste through a nozzle of an additive manufacturing machine (such as a liquid 3D printer or a fused deposition modelling device), the solvent evaporates and the residue undergoes self-assembly to form a jacket (in the form of a circular conduit) 102 that encapsulates the strand of liquid metal 104 as seen in the FIG. 1. The liquid metal extends from one end of the electrically conducting composite to the other thus providing the composite with a pathway to conduct electrical charges. The liquid metal retains its fluidic state at room temperature, allowing it to adapt seamlessly to various deformations.

In an embodiment, the strands obtained from the additive manufacturing process may be collected and subjected to spinning or braiding to form a textile or fabric. The fabric may then be fashioned into a wearable that may be attached to another device such as for example a smart watch that makes measurements of various body functions (e.g., blood pressure, arrythmias, and the like). The fabric may then be used in a sensor, an actuator, a smart fabric, a microcontroller, and so on.

The electrically conductive composite is advantageous because it the inherent malleability of the liquid metal strand, coupled with its ability to form continuous pathways even during deformation, makes it an ideal candidate for creating flexible and stretchable electronic circuits. This material not only ensures the integrity of electrical connections but also offers compatibility with elastomers, enhancing the overall stretchability of electronic components. Consequently, the incorporation of liquid metals into the domain of stretchable electronics presents unprecedented opportunities for advancing wearable devices, soft robotics, and biomedical applications, emphasizing the critical roles of flexibility and adaptability in these fields.

The electrically conducting composite and the method of manufacture thereof are detailed in the following non-limiting example.

### EXAMPLE

### Example 1

This example was conducted to demonstrate the manufacturing of a paste of the electrically conducting composite.

Poly (styrene-block-butadiene-block-styrene) (SBS) (30 wt % PS block) was provided by Kraton Co. (U.S.); 2-methyl-4′-(methylthio)-2-morpholinopropiophenone (1907) was obtained from TCI Chemical; 1H,1H,2H,2H-perfluorodecanethiol was purchased from Sigma-Aldrich (U.S.). The jacket was formed using poly(styrene-butadiene-styrene) (SBS), which self-assembles into a core/shell structure during printing. Additionally, a fluorinated version of SBS (SBS-F) was synthesized, enhancing the uniformity of the core/shell structure by utilizing the low surface energy of fluorinated polymers.

Tetrahydrofuran (THF) was obtained from Alfa Aesar Chemicals. Gallium (Ga, 99.99%) and Indium (In, 99.99%) were both sourced from Luciteria Science. The liquid metal (LM) used is a eutectic gallium-indium (EGaIn) alloy, which was prepared by mixing 74.5 wt % gallium and 25.5 wt % indium at 120° C.

Commercial non-reusable syringes (Becton Dickinson, 1.0 mL) and needles (Grainger blunt tip needle, 0.2 mm OD) were used for the liquid 3D printing. The syringes and needles created a printhead design that allowed for a very quick switch of syringes and needles (FIG. 1).

A representative ink formula is prepared by first mixing 25.0 wt % SBS in toluene, and then mixing the liquid metal with SBS toluene solution (4:1 in volume ratio). The liquid metal droplets are well dispersed in the SBS toluene solution. After 24 hours of standing, the liquid metal droplets remain independently distributed in the SBS toluene solution without aggregating into large-sized liquid metal drops. Gentle stirring is sufficient to disperse the liquid metal droplets evenly in the SBS toluene solution.

To achieve more effective self-assembly, particularly to promote the self-migration of the polymer to the surface of the liquid metal to more effectively protect the liquid metal, a fluorinated SBS (SBS-F) was synthesized. A representative ink formula is prepared by first mixing 30.0 wt % SBS-F in toluene/acetone mixed solvent (4:1 in volume ratio), then mixing liquid metal with the SBS solution (2:1 in volume ratio).

### Example 2

This example was conducted to demonstrate the manufacturing of the fluorinated SBS (SBS-F) by reacting SBS with 1H,1H,2H,2H-perfluorodecanethiol. 8.00 grams (g) SBS, 1.00 g of 1H, 1H,2H,2H-perfluorodecanethiol, and 10 milligrams (mg) photoinitiator 1907 were dissolved in 150 mL THF with stirring for 1 hour in a nitrogen atmosphere. Subsequently, the solution was irradiated with 365 nm UV light for 3 hours at room temperature with stirring. After the reaction was completed, the mixture was precipitated in ethanol. After filtration and drying, the final product SBS-F was obtained, whose structure was verified by ¹H NMR spectra. ¹H NMR (500M Hz, CDCl₃, ppm): 7.14-6.32 (benzene ring); 5.05-4.58 (—CH═CH—); 3.71-3.66 (—CH₂—S—, —CH—S—); 2.28 (—CH₂—F—); 1.97-1.19 (—CH₂—, —CH—).

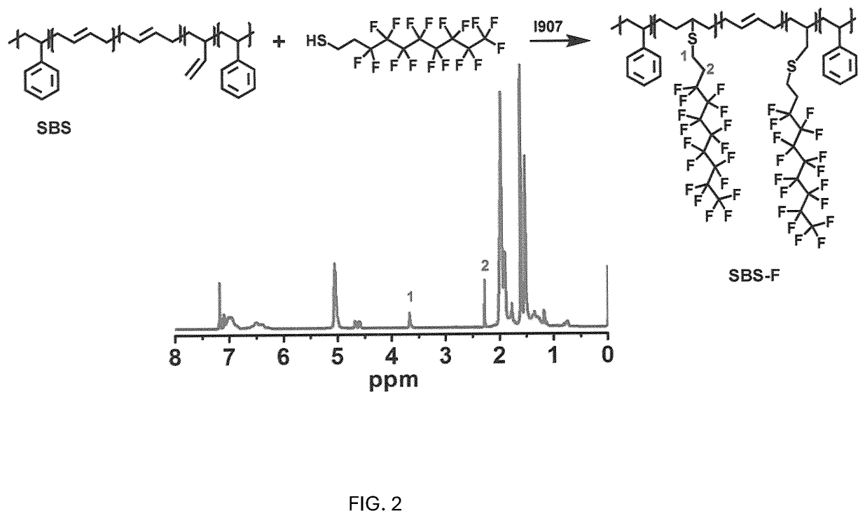

FIG. 2 shows the reaction to convert SBS to SBS-F. It also shows the NMR spectra that shows that the 1H, 1H,2H,2H-perfluorodecanethiol is covalently bonded to the SBS. ¹H NMR spectra were recorded on a Varian Mercury Plus 500 MHz instrument with tetramethylsilane (TMS) as the internal standard and chloroform-d (CDCl₃) as the solvent at room temperature. The surface morphology was captured by an optical microscope (AmScope, BH200-MR, USA). The liquid 3D printing set-up that we designed for this project was based on a 3D printer (Shenzhen Anycubic Technology Co. Ltd.) control frame and a syringe pump (New Era Pump System, Inc.).

### Example 3

The representative ink formula detailed in Example 1 (comprising 30.0 wt % SBS-F in toluene/acetone mixed solvent (4:1 in volume ratio) to create a SBS solution), then mixing the liquid metal with the SBS solution (2:1 in volume ratio) was subjected to liquid 3D printing to produce the electrically conducting composite. Direct liquid metal printing was used to produce the electrically conducting composite wherein stretchable liquid metal is precisely printed at desired locations through temperature and ink formula control. Here, the temperature of the printer head is 18° C., ensuring a viscosity of the solution that is effective for printing. The temperature of the substrate is 25° C. The increase in temperature of the substrate will accelerate the evaporation of solvents and the self-assembly of molecules.

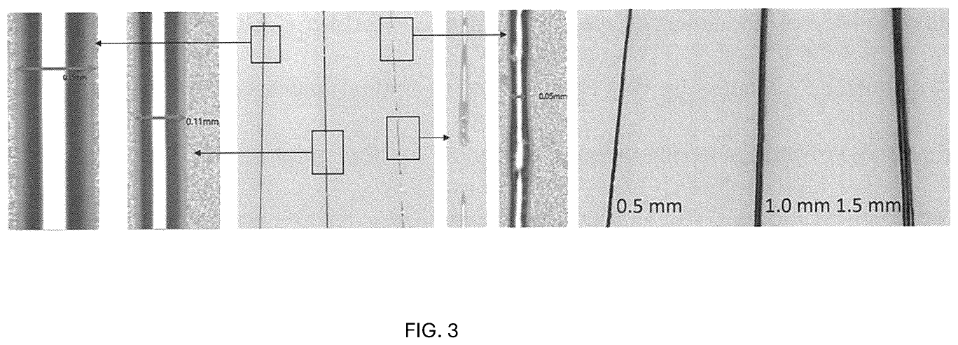

A mixture of the liquid metal and polymer is printed using direct printing and allowed to self-assemble to form a core/shell structure, with the polymer serving as the shell to protect the liquid metal core (FIG. 3). In this manner, the printed liquid metal is well protected and may be used for various applications. FIG. 3 depicts digital photographs of the printed liquid metal wires disposed on a polyurethane substrate at a pump speed of 1.6 microliters per second (μL/s) and a printing speed of 10 mm/s.

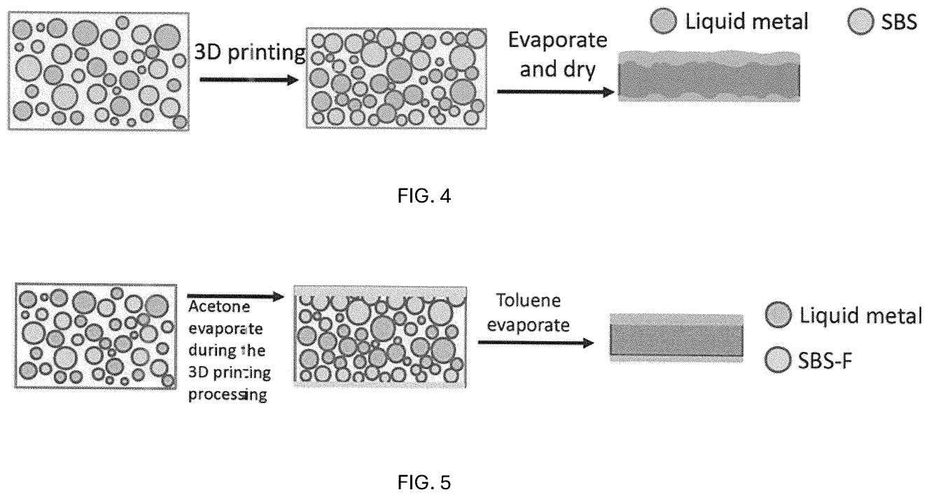

FIGS. 4 and 5 are schematic diagrams that depict a strategy to develop an ink formula that can self-assemble to form a liquid metal/polymer structure, where the liquid metal forms the core and the polymer forms the jacket (also known as the shell). In the FIG. 4, a mixture of the liquid metal (EGaIn) along with the SBS block copolymer is mixed with a solvent and printed on a substrate using direct printing. Upon deposition on the substrate, the solvent evaporates leaving the mixture to undergo self-assembly to form an SBS jacket (which forms the shell) on a liquid metal strand (which forms the core). From FIG. 4, it may be seen that the degree of separation between the jacket and the strand of liquid metal is limited leading to a broad interface between the two phases.

In FIG. 5, a mixture of the liquid metal (EGaIn) along with the fluorinated SBS block copolymer (SBS-F) is mixed with a solvent mixture (e.g., acetone and toluene) and printed on a substrate using direct printing. While being printed on the substrate (during the printing process), the acetone evaporates first leaving behind a mixture of the polymer and liquid metal in a toluene solvent. After deposition on the substrate, the toluene evaporates leaving the mixture to undergo self-assembly to form an SBS-F jacket (which forms the shell) on a liquid metal strand (which forms the core). From FIG. 5, it may be seen that the degree of separation between the jacket and the strand of liquid metal is well-defined leading to a sharp interface. This sharp-interface is due to the low surface energy of the fluorinated SBS block copolymer (SBS-F).

The use of temperature control from 3D printing digital settings combined with a self-assembling SBS protection layer results in the formation of a SBS-F jacket on a strand of liquid metal.

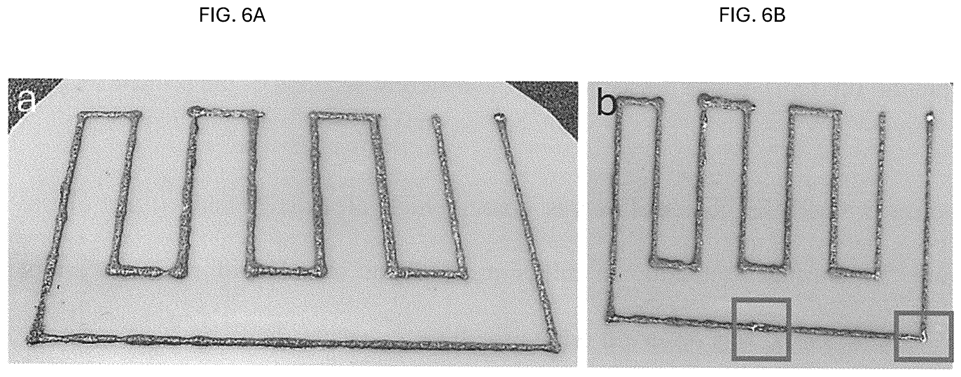

FIG. 6A is a photograph that depicts a strand of the electrically conducting composite that has a SBS jacket disposed on an EGaIn liquid metal core. FIG. 6B is a photograph that depicts two regions (see rectangles) of the electrically conducting composite strand that are sliced to expose the EGaIn liquid metal core strand inside the SBS jacket.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Various other components may be included and called upon for providing for aspects of the teachings herein. For example, additional materials, combinations of materials and/or omission of materials may be used to provide for added embodiments that are within the scope of the teachings herein. Adequacy of any particular element for practice of the teachings herein is to be judged from the perspective of a designer, manufacturer, seller, user, system operator or other similarly interested party, and such limitations are to be perceived according to the standards of the interested party.

In the disclosure hereof any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function.

Applicants thus regard any means which can provide those functionalities as equivalent to those shown herein. No functional language used in claims appended herein is to be construed as invoking 35 U.S.C. § 112 (f) interpretations as “means-plus-function” language unless specifically expressed as such by use of the words “means for” or “steps for” within the respective claim.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. The term “exemplary” is not intended to be construed as a superlative example but merely one of many possible examples.

While the invention has been described with reference to some embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. A composition for manufacturing an electrically conducting composite, the composition comprising:
a polymer comprising a surface energy reducing moiety; wherein the surface energy reducing moiety comprises a silicon atom, a fluorine atom, or both a silicon atom and a fluorine atom;
a liquid metal; and
a solvent; wherein the composition is operative to undergo self-assembly into an electrically conducting composite that comprises a jacket that comprises the polymer and a strand that comprises the liquid metal.

2. The composition of claim 1, wherein the polymer comprising the surface energy reducing moiety is a fluorinated polymer.

3. The composition of claim 1, wherein the fluorinated polymer is an elastomer at room temperature.

4. The composition of claim 3, wherein the elastomer comprises a block copolymer.

5. The composition of claim 4, wherein the block copolymer is styrene-butadiene-styrene with a fluorine-containing moiety grafted onto a backbone of a polymer chain.

6. The composition of claim 1, wherein the liquid metal is in a liquid state at a manufacturing temperature of the electrically conducting composite.

7. The composition of claim 1, where the liquid-metal in the liquid state from minus 100° C. to 85° C.

8. The composition of claim 1, wherein the liquid metal comprises an alloy of gallium, indium and tin; an alloy of bismuth, indium and tin; eutectic gallium-indium; and alloy of bismuth, lead, tin and cadmium; and alloy of bismuth, lead and tin: an alloy of sodium and potassium; and a mercury-based amalgam, which comprise mercury combined with one of silver, gold or tin; or a combination thereof.

9. The composition of claim 1, wherein the liquid metal is present in the electrically conducting composite in an amount of 80 to 95 wt %, based on a total weight of the electrically conducting composite.

10. The composition of claim 1, wherein the polymer is present in the electrically conducting composite in an amount of 5 to 20 wt %, based on a total weight of the electrically conducting composite.

11. The composition of claim 1, wherein the solvent comprises at least one of tetrahydrofuran, toluene, acetone, or a combination thereof.

12. An article comprising:
an electrically conducting composite comprising:
a liquid metal strand disposed in an encapsulating polymeric jacket; wherein the liquid metal strand extends continuously from one end to another end of the encapsulating polymeric jacket; and wherein the encapsulating polymeric jacket comprises a surface energy reducing moiety; wherein the surface energy reducing moiety comprises a low surface energy moiety.

13. The article of claim 12, wherein the article is electrically conducting upon being submitted to amounts of deformation greater than 100% of its original length.

14. The article of claim 12, where the article is a fiber.

15. The article of claim 14, where the fiber is woven into a fabric.

16. The article of claim 15, where the fabric is used in a sensor, an actuator, or a microcontroller.

17. A method of using an electrically conducting composite, the method comprising:
weaving the electrically conducting composite into a fabric; where the electrically conducting composite comprises:
a liquid metal strand disposed in an encapsulating polymeric jacket; wherein the liquid metal strand extends continuously from one end to another end of the encapsulating polymeric jacket; wherein the encapsulating polymeric jacket comprises a surface energy reducing moiety;
and wherein the surface energy reducing moiety is silicon atom, a fluorine atom, or both a silicon atom and a fluorine atom.

18. The method of claim 17, further comprising fabricating the fabric into a sensor, an actuator, an electrical or electronic device or a microcontroller.
